(19) United States
(12) Patent Application Publication
(10) Pub. No.: US 2016/0005330 A1
(43) Pub. Date: Jan. 7, 2016

(54) DEVICE FOR TEACHING THE AMHARIC LANGUAGE

(71) Applicant: ADN ACCESS DATA NETWORKS, Gennevilliers (FR)

(72) Inventor: Gilles Tugendhat, Paris (FR)

(21) Appl. No.: 14/752,140

(22) Filed: Jun. 26, 2015

(30) Foreign Application Priority Data
Jul. 2, 2014 (FR) 14 56324
Dec. 17, 2014 (FR) 14 62579

(51) Int. Cl. G09B 19/06; G09B 5/02

(52) U.S. Cl. CPC G09B 19/06; G09B 5/02

(57) ABSTRACT

A device designed to teach the Amharic language and standardize its script, including a computer keyboard containing a number of keys, including: an initial group of n biunivocal keys corresponding to n most frequent consonants or main consonants shown in the order 6; a second group of biunivocal keys, with a ≦n corresponding respectively to the main consonants presenting under order 1; a third group of biunivocal keys corresponding respectively to consonants other than the main consonants or secondary consonants presenting under order 6; and a keypad of eight silent keys corresponding respectively to eight orders, where pressing one of the silent keys on this keypad before pressing a biunivocal key corresponding to a main consonant or a secondary consonant will result in printing the main or secondary consonant under the order corresponding to the silent layer.

### CROSS-REFERENCE TO RELATED APPLICATIONS

This application claims priority to French Application No. 14 62579 filed Dec. 17, 2014 and French Patent Application No. 14 56324 filed Jul. 2, 2014, the entire disclosures of which are hereby explicitly incorporated by reference herein.

### BACKGROUND OF THE INVENTION

1. Field of the Invention

The present invention relates to device that will make it easier to teach the Amharic language and standardize the way in which it is written.

2. Description of the Related Art

The Latin alphabet, the one in most widespread use, employs 7-bit coding, leaving one bit accessible for special characters, such as those to which Amharic characters belong.

In the past, each language that uses special characters created its own encoding (of the ISO type).

In order to overcome the lack of uniformity and the problems of information transfer, in 1996, a general encoding system was defined that fixed, once and for all, the encoding of special characters in all languages. This was UTF 8.

Currently, many types of computer keyboards can be found in the marketplace that were designed for printing various scripts in different languages such as, for example, the QWERTY keyboard for English-speaking countries or the AZERTY keyboard for French-speaking countries.

Such keyboards are adapted, as a general rule, for alphabetic scripts in which the symbols represent sounds or phonemes, but it is harder to design keyboards suitable for syllabic scripts in which symbols represent syllables or for scripts, such as Amharic, that are midway between alphabetic and syllabic scripts.

Currently, no keyboard exists that can be used for reproducing Amharic script and that is of such a nature as to enable it to be satisfactorily used universally.

### SUMMARY OF THE INVENTION

The device includes a computer keyboard that has been adapted for communication and printing in the Amharic alphabet.

This computer keyboard consists of a set of keys like those on any other keyboard. Pressing a key sends a specific encoded signal to the computer that enables the printing of the alphanumeric character associated with that key.

The keyboard is thus an entry peripheral for the computer and is combined with a matrix network consisting of a set of lines and columns that make it possible to identify each of the keys.

Pressing a key will create an electrical contact between a line and a column of the matrix network that is of such a nature as to enable its transmission to the computer via an encoded signal micro-controller identifying the alphanumeric character associated with the said key that will then print the character.

In such a system, the characters are stored in a coded form.

In one form thereof, the present invention provides a device that facilitates the teaching of the Amharic language and standardizes its script consisting schematically of twenty-nine consonants that can be presented under eight orders, the device consisting of a computer keyboard consisting of a set of keys, the activation of any of these keys resulting in the transmission to the computer of a specific, encoded signal making it possible to print its associated alphanumeric character, the Amharic keyboard consisting of:

an initial group of n biunivocal keys corresponding to n most frequent consonants or main consonants presenting under order 6;

a second group of biunivocal keys, with ≦n corresponding respectively to the main consonants shown under order 1;

a third group of biunivocal keys corresponding respectively to consonants other than the main consonants or the secondary consonants presenting under order 6; and

a keypad of eight silent keys corresponding respectively to the eight orders; the activation of any of the silent keys on this keypad, prior to hitting a biunivocal key corresponding to a main consonant or secondary consonant, will print this main or secondary consonant in the order corresponding to that of the silent key.

The Amharic language is a Semitic, non-standardized language currently spoken by 30 million inhabitants of Ethiopia, 70% of whom are illiterate. It constitutes the vehicle for administration.

This language is commonly represented by something like two hundred and seventy characters consisting of thirty-four consonant roots or consonants each of which may belong to eight main states or orders, seven of which represent vocal declensions of the simple vowel type, the eighth representing a diphthong.

The characters of the Amharic language are shown in the table in Appendix 1.

To simplify matters in the context of this explanation, consonants with an equivalent or identical sound have been grouped together so that the Amharic alphabet can be considered to consist of 29 consonants, each of which may present under any of eight orders.

The characters of Amharic script thus simplified are shown in table 1 bis.

The earliest texts written in Amharic date from the fifth century AD but the script has only been learned by intellectuals or scholars, something that has largely contributed to the very low level of education of the population. A study of the Amharic language has revealed serious discrepancies between the written and the spoken language.

Such keyboards are adapted, as a general rule, for alphabetic scripts in which the symbols represent sounds or phonemes, but it is harder to design keyboards suitable for syllabic scripts in which symbols represent syllables or for scripts, such as Amharic, that are midway between alphabetic and syllabic scripts.

To remedy this unfortunate situation it would be very useful to have a device that would facilitate the teaching of the Amharic language, one that would also make it possible to standardize the script, in particular a computer keyboard adapted for printing in the Amharic script.

Such a keyboard would, in fact, constitute a tool that would be easily accessible to children and to illiterate adults, thus making it easier to teach the Amharic language, and effectively combating illiteracy.

To achieve this goal, the idea has already been mooted of designing keyboards based on the QWERTY keyboard on which the Amharic characters are artificially broken down phonetically so that they can be reproduced and printed by means of simultaneous or consecutive activation of at least two keys.

These keyboards are based on a special piece of non-standardized software called “Power Gueuze” but which, for example, makes it impossible to send emails.

This encoding is performed in ISO format.

This encoding is performed in ISO format so that it is not possible to transmit editable files.

Furthermore, use of this type of keyboard is reserved for a literate elite and for specially trained typists who are also required to master hundreds of combinations that are not displayed; it is thus desirable to be able to offer an alpha syllabic computer keyboard adapted for Amharic script, that would be accessible to the largest number of people and especially to children, making it possible to reproduce a significant proportion of the characters in Amharic script by activating a single key.

Such a keyboard would, in fact, have multiple advantages, including the possibility of the rapid teaching of Amharic and internet usage, the creation of a vehicle for the standardization of the Amharic language for Ethiopia and generalized communal access to Amharic via the web.

The present invention is to achieve this by proposing a device that would facilitate the teaching of the Amharic language and that would standardize the script by means of a computer keyboard of the abovementioned type.

The design of this keyboard is based on a thorough statistical analysis of the Amharic language and script, achieved through the study of eleven million characters written in this script and confirming the discrepancy between the written language and the spoken language.

The results of this analysis are grouped in Appendix 2, in which the two hundred and twenty-nine characters of the Amharic script are listed, defining each by its associated consonant and the order in which this consonant is shown; the characters are classified on the basis of their number and their frequency of occurrence.

The analysis has made it possible to establish that among the two hundred and twenty-nine characters of the Amharic language, forty-six occur in nearly 77% of cases.

An analysis of these forty-six characters has further shown that they consist of only seventeen consonants or major consonants, mainly presenting in order 6, more rarely in orders 3 and 4, and even more rarely in orders 3 and 7.

This statistical study was subsequently supplemented, still on the basis of the same eleven million characters, by a more detailed analysis, the results of which have been collected in Appendix 3 in which the twenty-nine consonants in Amharic script are listed, regardless of the order in which they present themselves. These consonants are classified again on the basis of the number and frequency of their occurrence.

This second study made it possible to establish that the seventeen major consonants accounted for 92.90% of occurrences while the other twelve minor consonants only accounted for 7.10%.

Through the invention, this prior statistical study enabled the design of a keyboard that makes it possible to reproduce a very significant proportion (in the order of 80%) of characters in Amharic script by activating a single key, while typing the remaining characters (in the order of 20%) only requires the pressing of two keys in succession, with respect to the organization of the language and using an intuitive approach.

According to an initial mode of implementing the invention, an Amharic keyboard such as this is characterised by the fact that it contains:
an initial group of n biunivocal keys corresponding to the n most frequent consonants or main consonants presented under order 6;
a second group of biunivocal keys with a ≦n corresponding respectively to the main consonants and presented under order 1;
a third group of biunivocal keys corresponding respectively to consonants other than the main or secondary consonants presenting under order 6; and
a keypad of eight silent keys corresponding respectively to the eight orders.

These keys are called ‘silent’ to the extent that they play a role in composing the character. In fact, pressing such a key on its own will not produce a character, while combining it with a biunivocal key will compose the consonant corresponding to the key and order selected.

Pressing one of the silent keys in this eight-key keypad prior to activating a biunivocal key corresponding to a main consonant or secondary consonant will result in printing this main or secondary consonant in the order corresponding to the silent key.

According to this initial mode of producing the invention, n is generally somewhere between 15 and 20 and is preferably equal to 17.
a is, as a general rule, between 12 and 20 and is preferably equal to 16.

According to this initial method of creating the invention, the Amharic keyboard also contains a fourth group of biunivocal keys b, with b a corresponding respectively to b main consonants presenting under order 4.

In accordance with this initial form of the invention, b is generally somewhere between 8 and 15 but is preferably equal to 11.

The Amharic keyboard could also advantageously contain at least one additional biunivocal key representing a principal consonant presenting under order 3 or order 7.

According to a preferential characteristic of this initial mode of implementation of the invention, the Amharic keyboard consists, on the one hand, of an eight-key keypad of silent keys corresponding respectively to the eight orders and on the other hand to a set of fifty-eight biunivocal keys corresponding to fifty-eight characters.

This set of fifty-eight biunivocal keys consists of:
an initial group of seventeen keys corresponding to the seventeen main consonants presenting under order 6;
a second group of sixteen keys corresponding to sixteen main consonants presenting under order 1;
a third group of twelve keys corresponding to twelve secondary consonants presenting under order 6; and
a fourth group of eleven keys corresponding to eleven main consonants presenting under order 4 and an additional similar key corresponding to a main consonant presenting under order 3 as well as a second similar key corresponding to a main consonant presenting under order 7.

In accordance with the initial method of implementing the invention, the keys in this arrangement consisting of fifty-eight biunivocal keys, they could be advantageously arranged in four rows of keys, the keys in each of the groups of keys being arranged in these rows so as to constitute blocks of keys that are respectively contiguous with each other.

As an example, the Amharic keyboard can comply with the first method of implementation of the invention and can advantageously contain, from left to right:
a keypad corresponding to the second group of keys;
a keypad corresponding to the fourth group of keys;
a keypad corresponding to the first group of keys; and
a keypad corresponding to the third group of keys.

It is a good idea to group all the silent keys on the keypad at the bottom right of the Amharic keyboard.

Note that in an Amharic keyboard of this type, the similar keys could be incorporated between the two contiguous keypads on the lowest row of keys.

This keyboard could also consist of other similar keys, such as, in particular, punctuation keys.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is an illustration of an Amharic keyboard corresponding to a first embodiment of the present invention;

FIG. 2 is an illustration of an Amharic keyboard corresponding to a second embodiment of the present invention; and

FIG. is an illustration of an Amharic keyboard corresponding to a third embodiment of the present invention.

Corresponding reference characters indicate corresponding parts throughout the several views. Although the exemplifications set out herein illustrate embodiments of the invention, the embodiments disclosed below are not intended to be exhaustive or to be construed as limiting the scope of the invention to the precise forms disclosed.

### DETAILED DESCRIPTION

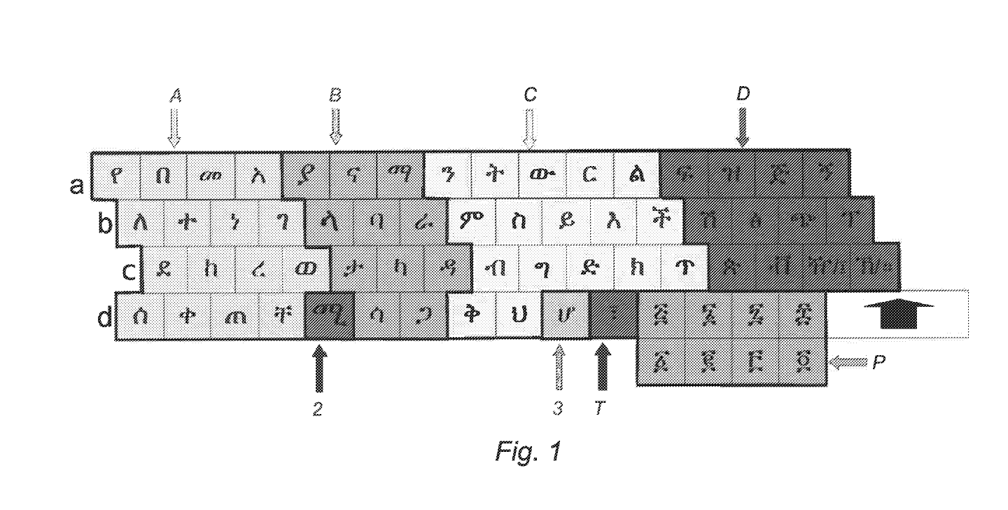

An Amharic keyboard corresponding to the first method of creation of the invention is represented in FIG. 1.

The silent keys correspond respectively to the eight orders of Amharic script.

According to FIG. 1, the Amharic keyboard consists basically of a keypad P consisting of eight silent keys at the bottom right of this keyboard, as well as a set of fifty-eight biunivocal keys arranged in four rows, a, b, c and d and corresponding respectively to the fifty-eight characters of Amharic script.

The set of fifty-eight biunivocal keys 1 can be broken down into four blocks of keys A, B, C and D, listed from left to right on the keyboard, with two similar keys 2 and 3.

Block A consists of a group of sixteen biunivocal keys 1 corresponding to the sixteen main consonants presenting under order 1.

Block B consists of a group of eleven biunivocal keys corresponding to the eleven main consonants presenting under order 4.

Block C consists of a group of seventeen biunivocal keys corresponding to the seventeen main consonants presenting under order 6.

Block D consists of a group of twelve biunivocal keys corresponding to the twelve secondary consonants all presenting under order 6.

Key 2 corresponds to a main consonant presenting under order 3 while key 3 corresponds to a main consonant presenting under order 7.

The keyboard also contains a punctuation key T. A keyboard using this kind of geometry represents a very advantageous compromise that can satisfy two requirements that would appear to be contradictory and making it possible to obtain a very high typing speed through printing a large number of the proposed characters by hitting a single key.

This keyboard in fact makes it possible to print out all the characters of a text written in Amharic script:
by hitting a single key in 78.89% of occurrences,
by hitting a silent key followed by a biunivocal key, i.e. two keys successively in 21.11% of occurrences, namely a biunivocal key corresponding to one of the seventeen main consonants in 16.18% of occurrences and one biunivocal key corresponding to one of twelve secondary consonants in 4.93% of occurrences.

In addition to the above mentioned statistical study, an analysis of the Amharic language and script was subsequently completed and refined. That is how it was realized that the language also contains eight vowels intrinsically, each of which has its own sound. They can be associated with the eight orders, of which the main consonant appearing in line 13 of appendix 1 bis (a) corresponds to the sounds of these vowels and can thus be omitted.

As a result of this more detailed analysis, on the table of consonants shown in appendix 1 bis, the thirteenth line can also be deleted so that the Amharic script in fact can be considered to consist of eight vowels rather than twenty-nine, as well as twenty-eight consonants, namely sixteen main consonants and twelve secondary consonants, each of which can be presented under eight orders that can be combined with eight vowels. Another result of this more detailed analysis is that in the table shown in appendix 3, the characters in rows 10 and 18 that correspond to the “consonant” shown on the thirteenth line of appendix 1 his can also be deleted.

Based on this analysis, we devised a scheme using a second method of implementation, one that was preferable for the invention, since it simplified the Amharic keyboard in a manner that corresponded to the first method of producing the invention. It involved designing an optimized Amharic keyboard based on the central part of the QWERTY keyboard and consisting at that level of a keypad of forty-four biunivocal keys, all of them corresponding to one of the sixteen main consonants thus defined and presented in a given order.

This optimized keyboard also contains, on the left-hand side, a keypad of eight silent keys corresponding to eight vowels or eight orders, and on the right-hand side a keypad of twelve biunivocal keys corresponding to twelve secondary consonants presenting under order 6.

In an optimized keyboard of this type, pressing one of the silent keys twice will print the vowel whose sound is shown on the key, while pressing one of the silent keys before pressing a biunivocal key corresponding to a main or secondary consonant, will print this main or secondary consonant in the order corresponding to that of the silent key.

In accordance with this second, preferable method of producing the invention, and so as to ensure that the central keypad on the keyboard corresponds to the forty-four key QWERTY keyboard, the table shown in appendix 3 has been analyzed and it has been decided that on this keypad, each of the main consonants should appear on at least two biunivocal keys, under at least two different orders.

Thus, from among the forty-seven initial characters in the table, apart from characters 10 and 18 that represent the ‘main consonant’ appearing on the 13th line of appendix 1 bis and thus in two vowels, character 46, representing the first secondary consonant, has been deleted.

Subsequently, according to this second method of preferable implementation, the invention concerns a device of the abovementioned type created by accepting that one of the main twenty-nine consonants in Amharic script actually represents the eight vowels respectively associated with one of the eight orders so that the script consists of eight vowels and twenty-eight consonants, namely sixteen main consonants and twelve secondary consonants, each of which can be presented under eight orders akin to the eight vowels.

This arrangement is characterised by the fact that the Amharic keyboard consists of:
a central keypad based on the QWERTY keyboard and consisting of forty-four biunivocal keys each corresponding to a main consonant shown in a given order, each of these main consonants appearing at least twice under different orders in the central keypad;
on the right-hand part of the central keypad, a block of twelve biunivocal keys representing respectively the twelve secondary consonants appearing under order 6; and
and on the left-hand side of the central keypad, a block of eight silent keys corresponding respectively to the eight orders and eight vowels and respectively identified by the sounds made by these vowels.

Note that in the Amharic keyboard represented by the second, preferable method of implementing the invention, pressing one of the silent keys twice will result in printing the associated vowel while pressing one of the silent keys prior to pressing a biunivocal key corresponding to a main consonant or a secondary consonant will result in printing this main or secondary consonant under the order corresponding to this silent key.

According to this second method of implementing the invention, the biunivocal keys on the central keypad, the biunivocal keys on the right-hand pad and the silent keys on the left-hand keypad are arranged in four rows so as to obtain a similar configuration to that of a QWERTY keyboard.

According to a preferred feature of this second method of implementing the invention, the central keyboard consists, from left to right, of three sequential blocks of keys, as follows:
a block of fifteen biunivocal keys corresponding to fifteen main consonants presenting under order 1;
a block of eleven biunivocal keys corresponding to eleven main consonants presenting under order 4; and
a block of sixteen biunivocal keys corresponding to sixteen main consonants presenting under order 6.

Note that in this keyboard, the right-hand block of the central keypad is placed close to the right-hand keypad of twelve biunivocal keys corresponding to the secondary consonants and there are twenty-eight biunivocal keys that correspond respectively to the twenty-eight consonants in the Amharic script presenting under order 6 that are collected on the right-hand side of this keyboard.

Such a configuration makes it much easier to use this keyboard.

According to another feature of this second method of producing the invention, the central keypad also contains an initial similar biunivocal key corresponding to a main consonant presenting under order 3 as well as a second similar biunivocal key corresponding to a main consonant presenting under order 7.

In an Amharic keyboard corresponding to the second, preferred method of producing the invention, the similar keys could be advantageously positioned on the upper line and lower line of this keyboard.

Other appended keys could, of course, be incorporated into this keyboard without their falling outside the scope of the invention.

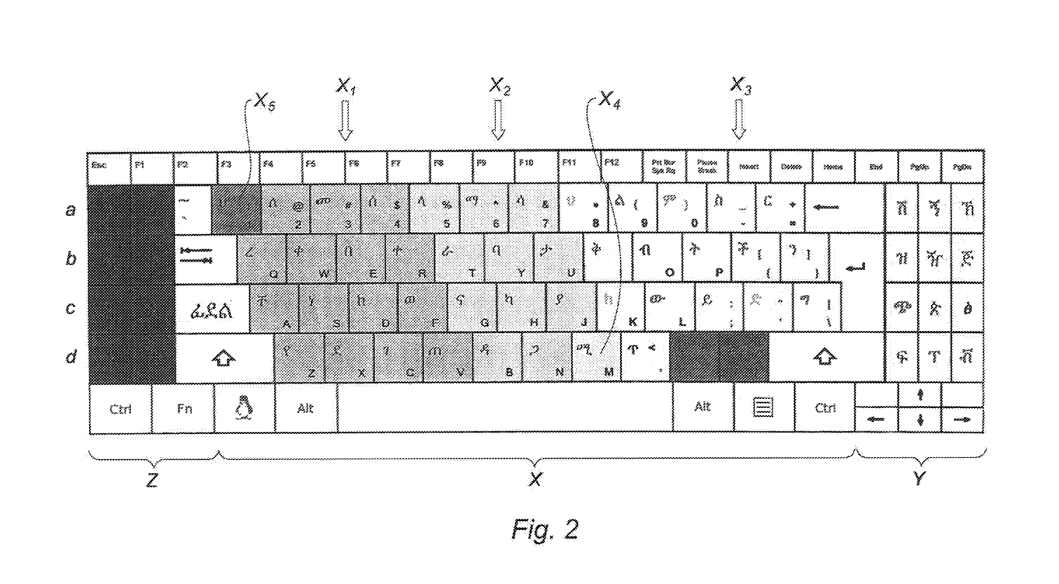

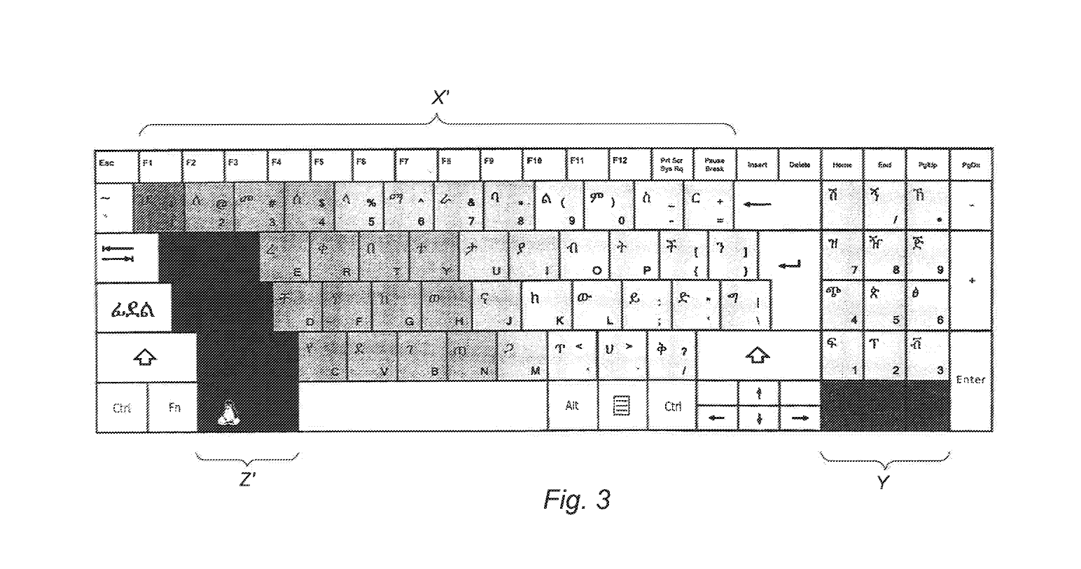

An Amharic keyboard corresponding to the second, preferable, method of implementation of the invention is shown in FIG. 2.

According to FIG. 2, the Amharic keyboard consists of a set of keys arranged in four rows, a, b, c and d.

These keys are more specifically distributed in a central keypad X based on the QWERTY keyboard, on a right-hand keypad Y and a left-hand keypad Z.

The central keypad consists of forty-four biunivocal keys each corresponding to a main consonant and presented in a given order, the arrangement of which will be described in greater detail subsequently.

The right-hand keyboard Y consists of twelve biunivocal keys corresponding respectively to the secondary consonants appearing under order 6.

The left-hand keypad Z consists of eight silent keys that correspond respectively to the eight orders and eight vowels of the Amharic language.

These keys are identified by the sound of the corresponding vowels.

The central keypad X is designed in such a way that the sixteen main consonants in the Amharic script appear at least twice under two different orders.

The central keypad X contains more specifically, moving from left to right, three blocks of sequential keys, X1, X2 and X3 respectively.

The left-hand block X1 consists of fifteen biunivocal key corresponding to fifteen main consonants presenting under order 1.

The central block X2 consists of eleven biunivocal keys that correspond to eleven main consonants presenting under order 4.

The right-hand block X3 consists of sixteen biunivocal keys that correspond respectively to sixteen main consonants presenting under order 6.

The configuration of this right-hand block X3 and the right-hand keypad Y means that they are next to each other and contain twenty-eight keys corresponding respectively to eighteen main consonants of the Amharic alphabet all shown under order 6.

In addition to the abovementioned keys, the central keypad X on the Amharic keyboard consists of an initial appended biunivocal key X4 corresponding to a main consonant presenting under order 3, located on the lower line b as well as a second biunivocal appended key X5 situated on the uppermost line a and corresponding to a main consonant presenting in order 7.

Note that the methods of producing the keyboard shown in FIGS. 1 and 2 are only given as examples and are in no way of such a nature as to impose a limitation on the invention.

In particular, FIG. 3 represents an alternative method of creating the Amharic keyboard in which the keypad for the vowels Z′ is inserted into a QWERTY X′ keypad of the main consonants and the number of keys corresponding to these main consonants is reduced from 44 to 40.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-8. (canceled)

9. A device for use in facilitating the teaching of the Amharic language and standardizing its script, the Amharic language including schematically twenty-nine consonants presentable under eight orders, the device comprising:
a computer keyboard including a set of keys, the keys actuable to transmit to a computer a specific, encoded signal to enable the computer to print an associated alphanumeric character associated with the signal, the Amharic keyboard comprising:
an initial group of n biunivocal keys corresponding to n most frequent consonants or main consonants presenting under order 6;
a second group of biunivocal keys, with ≦n corresponding respectively to the main consonants shown under order 1;
a third group of biunivocal keys corresponding respectively to consonants other than the main consonants or the secondary consonants presenting under order 6; and
a keypad of eight silent keys corresponding respectively to the eight orders, wherein the activation of any of the silent keys, prior to actuation of a biunivocal key corresponding to a main consonant or secondary consonant, will print a main or secondary consonant in the order corresponding to that of the silent key.

10. The device of claim 9, wherein n is a number between 15 and 20, and a is a number between 12 and 20.

11. The device of claim 10, wherein n is 17.

12. The device of claim 10, wherein a is 16.

13. The device of claim 9, wherein the Amharic keyboard includes a fourth group d of biunivocal keys with b≦a corresponding respectively to the b main consonants presenting under order 4, b representing a number between 8 and 15.

14. The device of claim 13, wherein b is 11.

15. The device of claim 9, wherein the Amharic keyboard further comprises:
a keypad of eight silent keys corresponding respectively to the eight orders, and
a set of fifty-eight biunivocal keys corresponding to fifty-eight characters, comprising:
an initial group of seventeen keys corresponding to seventeen main consonants presenting under order 6;
a second group of sixteen keys corresponding to sixteen main consonants presenting under order 1;
a third group of twelve keys corresponding to twelve secondary consonants presenting under order 6;
a fourth group of eleven keys corresponding to eleven consonants presenting under order 4;
a key corresponding to a main consonant presenting under order 3; and
a key corresponding to a main consonant presenting under order 7.

13. The device of claim 9, wherein one of the twenty-nine main consonants in Amharic script represents eight vowels respectively associated with one of the eight orders such that the script consists of eight vowels and twenty-eight consonants, including sixteen main consonants and twelve secondary consonants each of which can be presented under eight orders that are comparable to eight vowels, and wherein the Amharic keyboard comprises:
a central keypad based on the QWERTY keyboard and including forty-four biunivocal keys each corresponding to a main consonant presenting under a given order, each of the sixteen main consonants appearing at least twice in the central keypad;
on a right side of the central keypad, a keypad including twelve biunivocal keys corresponding respectively to the secondary consonants appearing under order 6; and
on a left side of the central keypad, a keypad of eight silent keys corresponding respectively to the eight orders and eight vowels and respectively identified by the sounds made by these vowels, wherein pressing any of the silent keys twice results in the printing of an associated vowel while the activation of any of the silent keys prior to that of a biunivocal key corresponds to a main consonant or a secondary consonant resulting in the printing of the main or secondary consonant in the order corresponding to the silent key.

16. The device of claim 15, wherein the biunivocal keys in the central keypad, the biunivocal keys of the right-hand keypad, and the biunivocal keys of the left-hand keypad are arranged in four rows.

17. The device of claim 15, wherein the central keypad includes, from a left side to a right side, of three blocks of keys that are respectively contiguous, including:
a first block of fifteen biunivocal keys corresponding to fifteen main consonants presenting under order 1;
a second block of eleven biunivocal keys corresponding to eleven main consonants presenting under order 4; and
a third block of sixteen biunivocal keys corresponding to sixteen main consonants presenting under order 6.

18. The device of claim 17, wherein the central keypad includes an initial appended biunivocal key corresponding to a main consonant presenting under order 3 as well as a second appended biunivocal key corresponding to a main consonant presented under order 7.
